(19) United States
(12) Patent Application Publication
(10) Pub. No.: US 2009/0223785 A1
(43) Pub. Date: Sep. 10, 2009

(54) SWITCH DEVICE FOR KEY OPERATION

(76) Inventors: Masatsugu Urakawa, Miyagi-ken (JP); Hiroyuki Bannai, Miyagi-ken (JP)

Correspondence Address: BRINKS HOFER GILSON & LIONE, P.O. BOX 10395, CHICAGO, IL, 60610, US

(21) Appl. No.: 12/395,881

(22) Filed: Mar. 2, 2009

(30) Foreign Application Priority Data
Mar. 5, 2008 (JP) 2008-055355

(51) Int. Cl. H01H 27/06

(52) U.S. Cl. 200/43.08

(57) ABSTRACT

A switch device for key operation includes a housing having a receiving recess at an inner bottom face of which an electrode pattern is disposed, a rotary holder rotatably disposed in the receiving recess to hold at least two movable contact members that are brought close to or separated from the electrode pattern, a bottomed recess formed in the rotary holder along its rotation axis, a slider disposed in a slidingly movable manner in the bottomed recess, a spring disposed within the bottomed recess so as to bias the slider in a direction opposite to an insertion direction of an external key when the external key is inserted into the bottomed recess, and a case having an opening allowing the slider to be exposed therethrough, and attached to the housing so as to cover the receiving recess. The at least two movable contact members respectively have extending pieces that extend into the bottomed recess. An intermediate connecting member that comes into resilient contact with each of the extending pieces, and slides when the external key is inserted into the bottomed recess is disposed in the slider.

### CROSS REFERENCE TO RELATED APPLICATIONS

The present application contains subject matter related to and claims priority to Japanese Patent Application JP2008-055355 filed in the Japanese Patent Office on Mar. 5, 2008, the entire contents of which is incorporated herein by reference.

### BACKGROUND

1. Technical Field

The present disclosure relates to a switch device for key operation to be used for a vehicle-mounted ignition switch or the like.

2. Related Art

In an automobile ignition switch, generally, when a key inserted into a key cylinder is rotationally operated, a rotor portion rotates integrally, and the contact position of a movable contact, which is secured to the rotor portion, with an electrode pattern of a stator portion changes, so that a switching operation according to the rotational positions (an ACC position, an ON position, and a start position) of the key can be performed. Also, a switch device for key operation is widely known which is adapted such that a switch for key detection, including a push switch or the like, is externally attached to this kind of ignition switch and the switch for key detection is operated by insertion of a key. However, when the switch for key detection is externally attached to the ignition switch, there is a problem in that the size of a whole device may be increased or the cost of parts may increase.

Thus, in the related art, a technique of providing a contact mechanism for key detection inside an ignition switch, thereby reducing the size of a device, or reducing cost, is suggested (for example, refer to Japanese Unexamined Patent Application Publication No. 2004-227871). This related-art technique will now be described. In the switch device for key operation disclosed in Japanese Unexamined Patent Application Publication No. 2004-227871, the contact mechanism for key detection is roughly constructed by connecting a pressing member, which slidingly moves by insertion of a key, with a movable contact via a first spring, always electrically connecting this movable contact with a first stationary contact via a second conductive spring, and providing a second stationary contact in a position that faces the movable contact so as to be brought close to or separated from the movable contact. In the contact mechanism for key detection that is roughly constructed as such, when the key is inserted into the key cylinder, the pressure member slidingly moves in its insertion direction (rearward). Therefore, the first spring is compressed to bias the movable contact toward the second stationary contact. As a result, since the movable contact moves rearward against the biasing force of the second spring, and contacts the second stationary contact, and the first stationary contact and the second stationary contact are electrically connected with each other with the movable contact and the second spring. Therefore, any insertion of the key into the key cylinder can be detected on the basis of a signal output by this electrical connection. Additionally, when the key is removed from the key cylinder, a compressive force to the first and second springs is removed, and the pressing member and the movable contact are pushed back to their original positions, respectively. Therefore, electrical connection between the first stationary contact and the second stationary contact is released.

However, in the contact mechanism for key detection in the aforementioned related art, the first spring and the second spring should be disposed so as to sandwich the movable contact from the front and rear sides, and a connecting structure between the movable contact and the pressing member is also complicated. Therefore, there is a problem in that the number of parts may increase, and assemblability may degrade. Additionally, when the movable contact biased by the first spring moves toward the second stationary contact, slight inclination resulting from required clearance may be caused in this movable contact. However, if the inclination of the movable contact becomes large due to dimension errors of parts, or the like, the movable contact is hardly brought into contact with the second stationary contact. Therefore, there is a concern in that poor electrical connection may be caused, and reliability may be damaged.

### SUMMARY

A switch device for key includes a housing having a receiving recess at an inner bottom face of which an electrode pattern is disposed; a rotary holder rotatably disposed in the receiving recess to hold at least two movable contact members that are brought close to or separated from the electrode pattern; a bottomed recess formed in the rotary holder along its rotation axis; a slider disposed in a slidingly movable manner in the bottomed recess; a spring disposed within the bottomed recess so as to bias the slider in a direction opposite to an insertion direction of an external key when the external key is inserted into the bottomed recess; and a case having an opening allowing the slider to be exposed therethrough, and attached to the housing so as to cover the receiving recess. The at least two movable contact members respectively have extending pieces that extend into the bottomed recess. An intermediate connecting member that comes into resilient contact with each of the extending pieces, and slides when the external key is inserted into the bottomed recess is disposed in the slider.

In the switch device for key operation constructed in this way, the bottomed recess for inserting a key portion at the tip of the key cylinder as an external key is formed. Thus, the slider disposed in the bottomed recess of the rotary holder can be slidingly moved against the biasing force of a spring (return spring), for example, by the insertion operation of the key into the key cylinder, and the intermediate connecting member can be brought into resilient contact with each of the extending pieces of the at least two movable contact members by this sliding movement. Therefore, even when slight inclination resulting from required clearance has been caused in the slider during the sliding movement, the intermediate connecting member can be reliably brought into electrical contact with the extending piece of each movable contact member, and a signal generated when any insertion of the key is detected can be taken out. Additionally, when the key is removed from the key cylinder, a compressive force to the spring is removed, and the slider is pushed back to its original position, so that the electric contact state between the extending piece of each movable contact member and the intermediate connecting member can be released. Additionally, since the rotary holder can be rotated by rotational operation of the inserted key, and the position of contact of the sliding piece with the electrode pattern changes by this rotational movement, the switch device can be operated as an ignition switch. Accordingly, the number of parts of the contact mechanism for key detection that is provided inside the ignition switch can be reduced, simplification of the structure becomes easy, and a high-reliable switch device for key operation can be provided.

### BRIEF DESCRIPTION OF THE DRAWINGS

FIG. 1 is an exploded perspective view of a switch device for key operation according to an embodiment of the invention;

FIG. 2 is a front view of the switch device for key operation;

FIG. 3 is a sectional view taken along a line III-III of FIG. 2;

FIG. 4 is a sectional view taken along a line IV-IV of FIG. 2;

FIG. 5 is an enlarged view of essential parts of FIG. 3, and an explanatory view showing an OFF state of a contact mechanism for key detection; and

FIG. 6 is an explanatory view showing an ON state of the contact mechanism for key detection.

### DESCRIPTION OF EXEMPLARY EMBODIMENTS

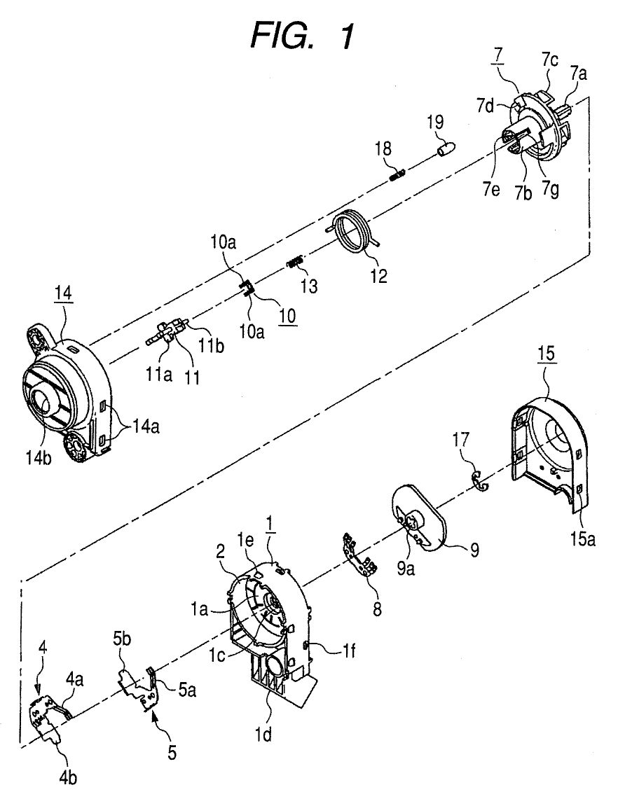

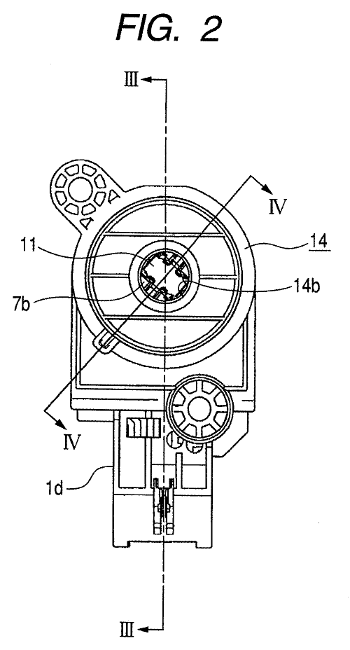

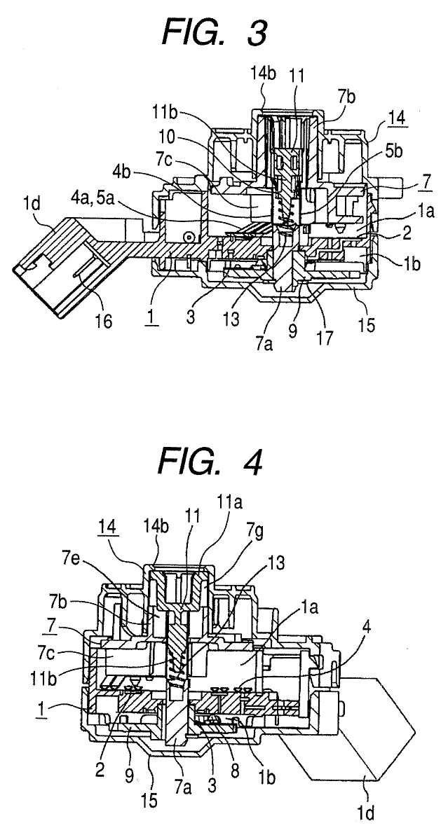

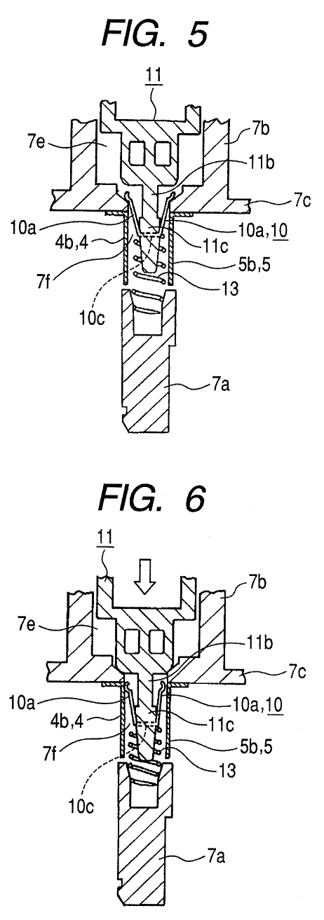

An embodiment of the invention will be described with reference to the accompanying drawings in which FIG. 1 is an exploded perspective view of a switch device for key operation according to the embodiment of the invention, FIG. 2 is a front view of the switch device for key operation, FIG. 3 is a sectional view taken along a line III-III of FIG. 2, FIG. 4 is a sectional view taken along a line IV-IV of FIG. 2, FIG. 5 is an enlarged view of essential parts of FIG. 3, and an explanatory view showing an OFF state of a contact mechanism for key detection, and FIG. 6 is an explanatory view showing an ON state of the contact mechanism for key detection.

The switch device for key operation shown in these drawings is one in which a contact mechanism for key detection is provided in an ignition switch. The switch device for key operation is composed mainly of a housing 1 having a receiving recess 1a, a rotary holder 7 disposed so as to be rotatable with respect to the housing 1, a slider 11 disposed so as to be slidingly movable within a bottomed recess 7e formed in the rotary holder 7, a spring (compression coil spring) 13 disposed so as to bias the slider 11 in a direction opposite to an insertion direction of an external key within the bottomed recess 7e, and a first case 14 attached to a front face (the left in the drawing) of the housing 1.

The housing 1 is made of synthetic resin, and as shown in FIG. 1, includes a receiving recess 1a opened to the front (the left in the drawing), a receiving recess 1b opened to the rear (the right in the drawing), a shaft hole 1c that allows central portions of the receiving recess 1a and the receiving recess 1b to communicate with each other, and a connector mounting portion id that protrudes sideways. An electrode pattern 2 is formed on an inner bottom face of the receiving recess 1a, and an electrode pattern 3 is formed on an inner bottom face of the receiving recess 1b. The electrode patterns 2 and 3 are exposed portions of a conductive metal plate embedded in the housing 1 by insert molding. A plurality of terminal pins 16 led out from the both electrode patterns 2 and 3 are arranged in a row in the connector mounting portion 1d, and an external connector (not shown) is connected to the terminal pins 16. Additionally, a plurality of locking claws 1e for snapping the first case 14 and a plurality of locking claws 1f for snapping a second case 15 protrude from an outer wall of the housing 1.

The rotary holder 7 is made of synthetic resin, and, as shown in FIG. 1, has a large-diameter holding portion 7c disposed in the receiving recess 1a of the housing 1 to hold movable contact members 4 and 5, a pivot portion 7a protruding rearward from the holding portion 7c and passing through the shaft hole 1c formed in the housing 1, and a tubular shaft portion 7b protruding forward from the holding portion 7c so as to surround a rotary shaft of the housing 1. The tubular shaft portion 7b is formed with a guide groove 7g that is engaged with a projection 11a of the slider 11 that will be described below, and guides the slider 11 in a direction of the rotation axis of the housing 1, and the inside of the tubular shaft portion 7b is formed with a bottomed recess 7e for inserting a key portion at the tip of a cylinder (not shown) as an external key. The bottomed recess 7e, as shown in FIGS. 3 and 4, has a narrow recess 7f that is formed so as to be narrow at its inner bottom face, and the extending piece 4b and 5b extending from the movable contact members 4 and 5 are disposed on an inner wall of the narrow recess 7f. Additionally, the front face of the holding portion 7c is formed with a click groove 7d, and a pair of movable contact members 4 and 5 is secured to a rear face of the holding portion 7c by heat fusion joining or the like. When a key inserted into the key cylinder (not shown) is rotationally operated, the rotary holder 7 rotates against the biasing force of a torsion coil spring 12 hung between the first case 14 and the rotary holder 7, so that the positions of contact of the sliding pieces 4a and 5a of the movable contact members 4 and 5 with the electrode pattern 2 may change.

The rotary plate 9 is made of synthetic resin, and is arranged in the receiving recess 1b of the housing 1. A sliding piece 8a of the movable contact member 8 that is brought close to or separated from the electrode pattern 3 formed on the inner bottom face of the receiving recess 1b in a resilient contact state is secured to the front face of the rotary plate 9 by heat fusion joining or the like. The rotary plate 9 has a non-circular shaft hole 9a at its central portion, and the pivot portion 7a and the rotary plate 9 are integrated by inserting the pivot portion 7a through the shaft hole 9a and locking the pivot portion by a stopper 17, such as an E ring. Therefore, when the key is rotationally operated, the rotary plate 9 rotates integrally with the rotary holder 7, and the positions of contact of the sliding piece 8a with the electrode pattern 3 changes. In addition, when the key rotates in the opposite direction after rotational operation, the rotary holder 7 and the rotary plate 9 reliably return to a given position by the biasing force of the torsion coil spring 12.

A pair of movable contact members 4 and 5 that is secured to the rotary holder 7 is formed by bending a conductive metal plate in a predetermined shape, and the movable contact member 4 is provided out of contact with the movable contact member 5. The movable contact members 4 and 5 are provided with sliding pieces 4a and 5a that extend toward an inner bottom face of the receiving recess 1a and come into resilient contact with the inner bottom face, and flat plate-shaped extending pieces 4b and 5b that extend along an inner wall face of the narrow recess 7f, and as shown in FIGS. 5 and 6, the extending pieces 4b and 5b of the pair of movable contact members 4 and 5 are arranged substantially in parallel to face each other. In addition, a first common pattern that the sliding piece 4a of the movable contact member 4 always comes into sliding contact with, and a second common pattern that the sliding piece 5a of the movable contact member 5 always comes into sliding contact with are provided in the electrode pattern 2 so as to be concentrically spaced apart from each other.

The slider 11 is made of synthetic resin, and has the projection 11a that is engaged with the guide groove 7g so that it can be slidingly moved in a front-back direction along the rotation axis of the rotary holder 7 while being guided by an inner wall face of the bottomed recess 7e within the tubular shaft portion 7b. The tip portion of the slider 11 is provided with a projecting portion 11b that is formed so as to be inserted into the narrow recess 7f. The projecting portion 11b has a large-diameter locking portion 11c between a root portion and a tip portion of the projecting portion 11b. An intermediate connecting member 10 made of a conductive metal plate is secured to the locking portion 11c by caulking or the like, and one end of a compression coil spring 13 is secured by press fitting or the like. When a key is inserted into the key cylinder (not shown), the slider 11 slidingly moves to the rear (the right in FIG. 1 or lower side in FIG. 5) against the biasing force of the compression coil spring 13, as shown in FIG. 6, a resilient piece 10a of the intermediate connecting member 10 comes into resilient contact with the extending pieces 4b and 5b of the movable contact members 4 and 5 and makes electrical contact therewith. Additionally, when the inserted key is removed from the key cylinder, the slider 11 slidingly moves to its original position (upper initial position in FIG. 5) by the biasing force of the compression coil spring 13, and as shown in FIG. 5, the resilient piece 10a is spaced apart from the extending pieces 4b and 5b.

The intermediate connecting member 10 is made of a conductive metal plate, and has a shaft hole 10c into which the projecting portion 11b is fitted, and a pair of resilient pieces 10a that comes into resilient contact with the extending pieces 4b and 5b while the tip of each resilient piece 10a is resiliently deformed toward the rotation axis of the rotary holder 7, when a key is inserted into the key cylinder (not shown), and the projecting portion lib is inserted into the narrow recess 7f. The resilient pieces 10a are formed so as to spread and extend outward toward a direction, which is opposite to the direction where the external key is inserted, from the intermediate connecting member 10.

The first case 14 is made of synthetic resin, and is open rearward. An outer wall of the first case is provided with a plurality of engaging holes 14a that are engaged with the locking claws 1e of the housing 1, and a central portion of a front end of the first case is provided with an opening 14b through which the tubular shaft portion 7b or the slider 11 is exposed. Additionally, the compression coil spring 18 and a pressing piece 19 are assembled into predetermined places of the first case 14 that face the holding portion 7c. When the rotary holder 7 is rotationally operated, the pressing piece 19 biased by the compression coil spring 18 is disengaged from the click groove 7d, which is formed in the face of the holding portion 7c on the side of the first case, to generate a click feeling. By fitting each locking claw 1e into each engaging hole 14a in a snapping manner, the first case 14 is attached to the housing 1 so as to cover the receiving recess 1a.

The second case 15 is made of synthetic resin, and is open forward. An outer wall of the first case is provided with a plurality of engaging holes 15a that are engaged with the locking claws if of the housing 1. By fitting each locking claw if into each engaging hole 15a in a snapping manner, the second case 15 is attached to the housing 1 so as to cover the rotary plate 9 or the receiving recess 1b.

In the switch device for key operation constructed in this way, the slider 11 is held in a position shown in FIG. 5 when the key is not inserted into the key cylinder. Therefore, the resilient pieces 10a of the intermediate connecting member 10 are in positions spaced apart from the extending pieces 4b and 5b of the movable contact members 4 and 5. When a key is inserted into the key cylinder, the slider 11 within the tubular shaft portion 7b is pushed in an insertion direction (lower side in FIG. 5) of the key via an actuator (not shown), such as a cam shaft. Therefore, the slider 11 and the intermediate connecting member 10 slidingly move against the biasing force of the compression coil spring 13. As a result, as shown in FIG. 6, the resilient pieces 10a come into resilient contact with the extending pieces 4b and 5b of the movable contact members 4 and 5. Therefore, the extending pieces 4b and 5b of the movable contact members 4 and 5 will be in an electrically connected state via the intermediate connecting member 10, and the first and second common patterns of the electrode pattern 2 will be in an electrically connected state. Additionally, when the inserted key is removed, the slider 11 is pushed back to its original position by the biasing force of the compression coil spring 13, and the resilient piece 10a is spaced apart from the extending pieces 4b and 5b. Therefore, the electrical connection between the first and second common patterns is released. Accordingly, the insertion operation of the key can be detected on the basis of signals output from the terminal pins 16 corresponding to the first and second common patterns.

When the key inserted into the key cylinder has been rotationally operated, the rotary holder 7 and the slider 11 are rotationally driven against the biasing force of the torsion coil spring 12 via the actuator. At this time, since the rotary plate 9 also rotates integrally with the rotary holder 7, the sliding pieces 4a and 5a and the sliding piece 8a rotate in the same direction. At this time, since the sliding pieces 4a, 5a, and 8a can be brought close to or separated from predetermined portions (contact patterns) of the electrode patterns 2 and 3 according to the rotational position of a key, switching operation according to the rotational positions (an ACC position, an ON position, and a start position) of the key can be performed, on the basis of signals output from the terminal pins 16 corresponding to these predetermined portions.

That is, when a key is inserted into the cylinder, the insertion operation of the key can be detected by a contact mechanism for key detection including the slider 11, the movable contact members 4 and 5, the intermediate connecting member 10, or the compression coil spring 13. When the inserted key is rotationally operated, the positions of contact of the movable contact members 4, 5, and 8 with the electrode patterns 2 and 3 changes. Therefore, the switch device for key operation according to this embodiment can be operated as an ignition switch. In this switch device for key operation, a structure in which the number of parts of the contact mechanism for key detection provided inside the ignition switch is a few can also be simplified. Additionally, in this contact mechanism for key detection, the resilient pieces 10a of the intermediate connecting member 10 can be reliably brought into contact with the movable contact member 5 even in a case where slight inclination resulting from required clearance occurs in the slider 11 during sliding movement. Therefore, high reliability can be expected without the possibility that the resilient pieces 10a and the movable contact member 5 cause poor electrical connection.

In addition, in the above embodiment, the number of circuits of the switch device for key operation is increased by adding the rotary plate 9 to which the movable contact member 8 is secured separately from the rotary holder 7 to which the movable contact members 4 and 5 are secured, and disposing the electrode patterns 2 and 3 on both front and rear faces of housing 1. However, when the number of circuits does not have to be increased particularly, configuration can be made simpler by omitting the movable contact member 8, the rotary plate 9, electrode pattern 3, or the like. Additionally, movable contact members that are secured to the holding portion 7c disposed in the receiving recess 1a may be three or more.

It should be understood by those skilled in the art that various modifications, combinations, sub-combinations and alternations may occur depending on design requirements and other factors insofar as they are within the scope of the appended claims of the equivalents thereof.

What is claimed is:

1. A switch device for key operation comprising:
a housing having a receiving recess at an inner bottom face of which an electrode pattern is disposed;
a rotary holder rotatably disposed in the receiving recess to hold at least two movable contact members that are brought close to or separated from the electrode pattern;
a bottomed recess formed in the rotary holder along its rotation axis;
a slider disposed in a slidingly movable manner in the bottomed recess;
a spring disposed within the bottomed recess so as to bias the slider in a direction opposite to an insertion direction of an external key when the external key is inserted into the bottomed recess; and
a case having an opening allowing the slider to be exposed therethrough, and attached to the housing so as to cover the receiving recess,
wherein the at least two movable contact members respectively have extending pieces that extend into the bottomed recess, and
wherein an intermediate connecting member that comes into resilient contact with each of the extending pieces, and slides when the external key is inserted into the bottomed recess is disposed in the slider.

2. The switch device for key operation according to claim 1,
wherein the bottomed recess has a narrow recess formed narrowly at an inner bottom face of the bottomed recess, the slider has a projecting portion inserted into the narrow recess when the external key is inserted into the bottomed recess, the spring is arranged within the narrow recess, each of the extending pieces extends along an inner wall of the narrow recess, and the intermediate connecting portion has a resilient piece locked between a root portion and a tip portion of the projecting portion and comes into resilient contact with each of the extending pieces and slides when the external key is inserted into the bottomed recess.
